(19) United States
(12) Patent Application Publication
(10) Pub. No.: US 2022/0412575 A1
(43) Pub. Date: Dec. 29, 2022

(54) AIR CONDITIONER

(71) Applicant: Yiyong Huang, Brooklyn, NY (US)

(72) Inventor: Yiyong Huang, Brooklyn, NY (US)

(21) Appl. No.: 17/848,382

(22) Filed: Jun. 23, 2022

(30) Foreign Application Priority Data
Jun. 28, 2021 (CN) 202121452392.7

(51) Int. Cl. F24F 1/0068

(52) U.S. Cl. CPC F24F 1/0068

(57) ABSTRACT

An air conditioner comprises a first refrigeration cycle and a second refrigeration cycle. The first refrigeration cycle comprises an evaporator, a condenser, a compressor and a throttle valve; the evaporator, the condenser, the compressor and the throttle valve are connected to form a first loop; the first refrigeration cycle further comprises a refrigerant which circulates in the first loop; the second refrigeration cycle comprises an antifreeze fluid tank, a pump and a heat exchanger; the antifreeze fluid tank, the pump and the heat exchanger are connected into a second loop; the second refrigeration cycle further comprises an antifreeze fluid which circulates in the second loop; the evaporator is installed in the antifreeze fluid tank and immersed in the antifreeze fluid in the antifreeze fluid tank. The air conditioner is novel in design and high in practicability.

### CROSS REFERENCE TO RELATED APPLICATIONS

The present application claims the benefit of Chinese Patent Application No. 202121452392.7 filed on Jun. 28, 2021, the contents of which are incorporated herein by reference in their entirety.

### TECHNICAL FIELD

The present application relates to the field of temperature regulating equipment, in particular to an air conditioner.

### BACKGROUND

At present, there are two kinds of split air conditioners: fixed frequency and variable frequency.

For fixed-frequency air conditioners, in order to maintain the indoor temperature near the set temperature, it is usually realized by switching the compressor on and off frequently. However, it takes a period of time from the start of the compressor to the normal operation of the refrigeration system to produce cold air. During this period of time, the fixed-frequency air conditioner cannot be cooled, and the power consumed is wasted. At the same time, when the compressor stops working, the refrigeration system will soon stop cooling. Therefore, the temperature stabilization control scheme of the fixed-frequency air conditioner is relatively rough and wastes a lot of electric energy.

For inverter air conditioners, after the indoor temperature drops to the set temperature, the operating frequency of the compressor will be reduced, thereby reducing the cooling speed of the refrigeration system. When cooling speed of the refrigeration system is consistent with the rate of cold air consumed indoor, the indoor temperature can be maintained at the set temperature. The temperature stabilization control scheme of the inverter air conditioner is relatively sophisticated, but the cost of the compressor and the corresponding control circuit of the inverter air conditioner is much higher.

### SUMMARY

The present application provides an air conditioner aiming at the above technical problems.

The technical scheme proposed by the present application is as follows:

an air conditioner, wherein, comprises a first refrigeration cycle and a second refrigeration cycle;

the first refrigeration cycle comprises an evaporator, a condenser, a compressor and a throttle valve; an outlet of the evaporator is connected with an inlet of the compressor, an outlet of the compressor is connected with an inlet of the condenser, an outlet of the condenser is connected with an inlet of the evaporator through the throttle valve, making the evaporator, the condenser, the compressor and the throttle valve being connected to form a first loop; the first refrigeration cycle further comprise a refrigerant which circulates in the first loop;

the second refrigeration cycle comprises an antifreeze fluid tank, a pump and a heat exchanger; an outlet of the antifreeze fluid tank is connected with an inlet of the pump, an outlet of the pump is connected with an inlet of the heat exchanger, an outlet of the heat exchanger is connected with an inlet of the antifreeze fluid tank, making the antifreeze fluid tank, the pump and the heat exchanger being connected to form a second loop; the second refrigeration cycle further comprises an antifreeze fluid which circulates in the second loop;

the evaporator is installed in the antifreeze fluid tank and immersed in the antifreeze fluid in the antifreeze fluid tank.

In the air conditioner of the present application, the heat exchanger is arranged indoors, and the condenser and the compressor are arranged outdoors.

In the air conditioner of the present application, the evaporator is arranged indoors or outdoors.

In the air conditioner of the present application, the air conditioner further comprises a heating wire arranged in the antifreeze fluid tank for heating the antifreeze fluid.

In the air conditioner of the present application, the air conditioner further comprises a first fan arranged near the heat exchanger for pumping air near the heat exchanger to form an air flow.

In the air conditioner of the present application, the air conditioner further comprises a second fan arranged near the condenser for pumping air near the condenser to form an air flow.

In the air conditioner of the present application, there are multiple second refrigeration cycles, and multiple second refrigeration cycles share the same antifreeze fluid tank.

The air conditioner of the present application uses antifreeze fluid to store the cooling capacity. After the indoor temperature drops to the set temperature, the pump is turned off to stop cooling the air; the air is cooled again when the pump is turned on. Since controlling the pump to be turned on or off can be easily realized, the indoor temperature can be precisely adjusted. When the pump is turned off, since the cooling capacity is stored in the antifreeze fluid tank, the cooling capacity is not consumed by the antifreeze fluid in the antifreeze fluid tank (of course, the antifreeze fluid tank and pipeline cannot be completely insulated, and there will be some cooling capacity leakage), and the temperature will be nearly constant. When the pump is turned on, the cooling capacity stored in antifreeze fluid tank will be continuously consumed, and the temperature in the antifreeze fluid tank will continue to rise. When the temperature in the antifreeze fluid tank rises to the set value, the compressor starts to work, and the first refrigeration cycle starts to produce cooling capacity. The antifreeze fluid absorbs the cooling capacity, and the temperature will continue to decrease. When the temperature decreases to the set value, the compressor stops working. The opening and closing of the compressor are controlled according to the consumption rate of antifreeze liquid cooling capacity, rather than directly controlled by temperature, so it is not necessary to turn on and turn off it frequently. Therefore, the function of fine temperature adjustment of the inverter air conditioners is realized by the fixed-frequency compressor of the air conditioner of the present application, and the energy consumption is also reduced. The air conditioner of the present application is novel in design and high in practicability.

### DESCRIPTION OF THE DRAWINGS

The present application will be further described below in combination with the attached drawings and embodiments. In the attached drawings:

FIG. 1 shows the principle diagram of the air conditioner in the first embodiment of the present application;

FIG. 2 shows the principle diagram of the air conditioner in the second embodiment of the present application;

FIG. 3 shows the principle diagram of the air conditioner in the third embodiment of the present application.

### DETAILED DESCRIPTION OF THE PREFERRED EMBODIMENT

In order to make the technical purpose, technical scheme and technical effect of the present application more clear, and to facilitate those skilled in the art to understand and implement the present application, the present application will be further described in detail below in combination with the attached drawings and specific embodiments

### The First Embodiment

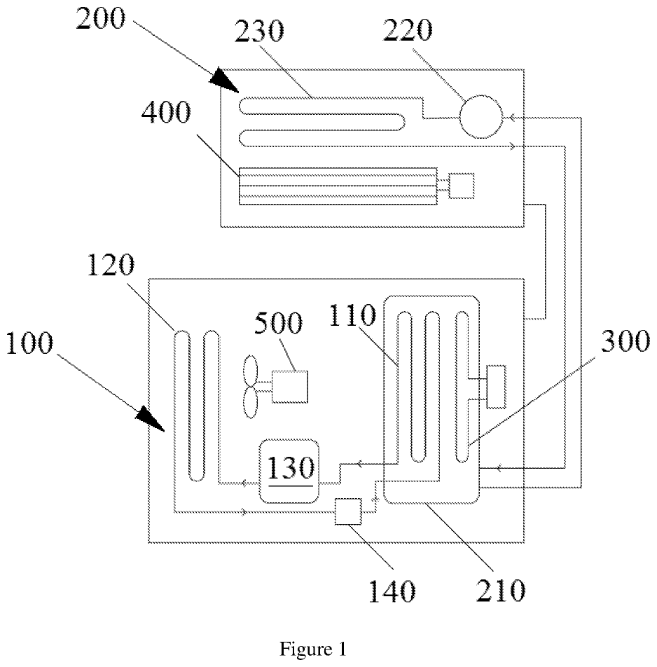

As shown in FIG. 1, which shows the principle diagram of the air conditioner in the first embodiment of the present application, the air conditioner comprises a first refrigeration cycle 100 and second refrigeration cycle 200;

the first refrigeration cycle 100 comprises an evaporator 110, a condenser 120, a compressor 130 and a throttle valve 140; an outlet of the evaporator 110 is connected with an inlet of the compressor 130, an outlet of the compressor 130 is connected with an inlet of the condenser 120, an outlet of the condenser 120 is connected with an inlet of the evaporator 110 through the throttle valve 140, making the evaporator 110, the condenser 120, the compressor 130 and the throttle valve 140 being connected to form a first loop; the first refrigeration cycle 100 further comprise a refrigerant which circulates in the first loop;

the second refrigeration cycle 200 comprises an antifreeze fluid tank 210, a pump 220 and a heat exchanger 230; an outlet of the antifreeze fluid tank 210 is connected with an inlet of the pump 220, an outlet of the pump 220 is connected with an inlet of the heat exchanger 230, an outlet of the heat exchanger 230 is connected with an inlet of the antifreeze fluid tank 210, making the antifreeze fluid tank 210, the pump 220 and the heat exchanger 230 being connected to form a second loop; the second refrigeration cycle 200 further comprises an antifreeze fluid not shown in the Figure which circulates in the second loop;

the evaporator 110 is installed in the antifreeze fluid tank 210 and immersed in the antifreeze fluid in the antifreeze fluid tank 210.

The above technical scheme is the basic scheme. For the first refrigeration cycle 100, the compressor 130 sucks the working medium steam refrigerant with lower pressure from the evaporator 110, increases its pressure, and sends it to the condenser 120, where it is condensed into a liquid refrigerant with higher pressure. After throttled by the throttle valve 140, it becomes a liquid with lower pressure, and then is sent to the evaporator 110, where it absorbs heat and is evaporated into a steam with lower pressure. And the first refrigeration cycle is completed. For the second refrigeration cycle 200, since the evaporator 110 is immersed in the antifreeze fluid tank 210, the antifreeze fluid tank 210 can obtain the cooling capacity produced by the first refrigeration cycle 100 through heat transfer, and the pump 220 can deliver the cooling capacity to the heat exchanger 230 to realize the cooling function. This embodiment uses antifreeze fluid to store the cooling capacity. After the indoor temperature drops to the set temperature, the pump is turned off to stop cooling the air; the air is cooled again when the pump is turned on. Since controlling the pump to be turned on or off can be easily realized, the indoor temperature can be precisely adjusted. When the pump is turned off, since the cooling capacity is stored in the antifreeze fluid tank 210, the cooling capacity is not consumed by the antifreeze fluid in the antifreeze fluid tank (of course, the antifreeze fluid tank and pipeline cannot be completely insulated, and there will be some cooling capacity leakage), and the temperature will be nearly constant. When the pump is turned on, the cooling capacity stored in antifreeze fluid will be continuously consumed, and the temperature in the antifreeze fluid tank will continue to rise. When the temperature in the antifreeze fluid tank rises to the set value, the compressor starts to work, and the first refrigeration cycle 100 starts to produce cooling capacity. The antifreeze fluid absorbs the cooling capacity, and the temperature will continue to decrease. When the temperature decreases to the set value, the compressor stops working. The opening and closing of the compressor are controlled according to the consumption rate of antifreeze liquid cooling capacity, rather than directly controlled by temperature, so it is not necessary to turn on and turn off it frequently. Therefore, the function of fine temperature adjustment of the inverter air conditioners is realized by the fixed-frequency compressor of the air conditioner of the present application, and the energy consumption is also reduced.

It can be understood that the heat exchanger 230 is arranged indoors, and the condenser 120 and the compressor 130 are arranged outdoors. Further, in this embodiment, the evaporator 110 is arranged outdoors.

Further, in this embodiment, freon is used as the refrigerant. Antifreeze fluid is a common antifreeze coolant for automobile engines, and its freezing point is less than or equal to −30° C. The antifreeze fluid used by the air conditioner of the present application transmits the cooling capacity produced by the first refrigeration cycle 100 to the indoor heat exchanger 230 of the second refrigeration cycle 200, which can easily make the internal temperature of the heat exchanger reach the required temperature (for example, at present, the split air conditioner is usually at −7° C.), and the temperature can be adjusted in a larger range according to the needs. It also has a wider adjustment range than the situation where water is used as the refrigerant in the second refrigeration cycle 200. When using water as the refrigerant, the minimum internal temperature of the heat exchanger can only be close to 0° C.

Further, in this embodiment, the air conditioner also includes a heating wire 300 arranged inside the antifreeze fluid tank 210 for heating the antifreeze fluid. When the air conditioner is used for heating, the antifreeze fluid tank, the heating wire, the pump and the heat exchanger together form a heating system, which is used to transfer the heat generated by the heating wire to the indoor heat exchanger to heat the indoor air.

In this embodiment, the first refrigeration cycle of the present application is fully enclosed and integrated, so the refrigerant used for the same power is less, and there is no leakage, so no refrigerant needs to be added for maintenance. The output pipe and return pipe of antifreeze fluid are connected from outdoor to indoor. There is no high pressure and gas state during operation. Antifreeze liquid is liquid under normal temperature and pressure. It only needs ordinary plastic barrels for storage the antifreeze liquid, and steel cylinders used for refrigerant are not needed. Therefore, the air conditioner of the present application is much more convenient in installation and maintenance than the commonly used split air conditioner at present.

Further, in the present embodiment, the air conditioner also comprises a first fan 400 arranged near the heat exchanger 230 for pumping air near the heat exchanger 230 to form an air flow.

The air conditioner also comprises a second fan 500 arranged near the condenser 120 for pumping air near the condenser 120 to form an air flow.

In this embodiment, the heat exchanger, the pump and the first fan constitute an indoor unit; the throttle valve, the evaporator, the antifreeze fluid tank, the heating wire, the compressor, the condenser and the second fan constitute the outdoor unit.

### The Second Embodiment

Compared with the first embodiment, the second embodiment is different in that there are multiple second refrigeration cycles 200, and multiple second refrigeration cycles 200 share the same antifreeze fluid tank 210.

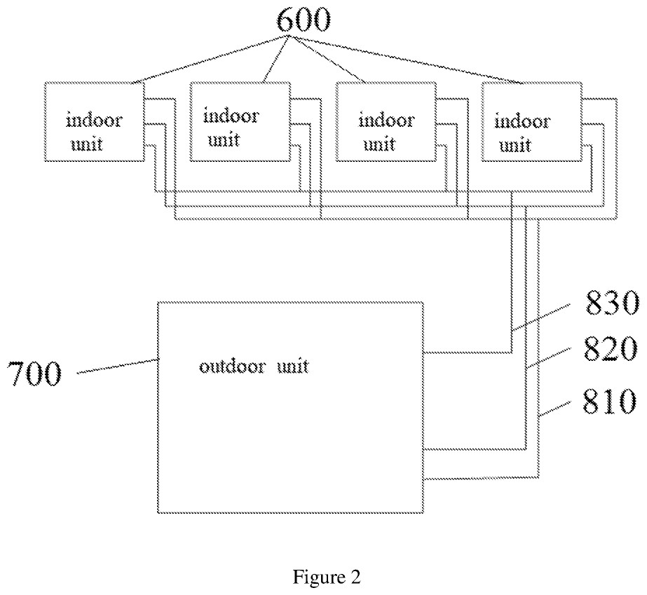

As in the first embodiment, in this embodiment, the heat exchanger, the pump and the first fan constitute the indoor unit 600; the throttle valve, the evaporator, the antifreeze fluid tank, the heating wire, the compressor, the condenser and the second fan constitute the outdoor unit 700. The present application can easily realize the function of an outdoor unit driving multiple indoor units, that is, the so-called two-driven-by-one, three-driven-by-one, four-driven-by-one, etc. Take four-driven-by-one as an example, as shown in FIG. 2, which shows the schematic diagram of the air conditioner in the second embodiment of the present application. It is only necessary to simply connect the output pipes 810, the return pipes 820 and the control wires 830 of the outdoor unit and the four indoor units correspondingly. Since each indoor unit has its own pump, it can control whether the indoor unit circulates with the antifreeze fluid of the outdoor unit according to its own needs. For the indoor unit that has not been started up or the indoor unit that has been started up but the temperature has dropped to the required level and does not need cooling air for the time being, the pump is turned off to stop the circulation of the antifreeze fluid, so the cooling capacity will not be consumed. For the indoor unit that needs cooling air, the pump is turned on to make the circulation of the antifreeze fluid of the outdoor unit normally to consume the cooling capacity. As long as one or more units are still in the startup state, the outdoor unit will be in the normal working state, and the working state of the compressor will be controlled according to the temperature change of the antifreeze fluid in the antifreeze fluid tank. Therefore, this system is convenient for each indoor unit to adjust the temperature in this area according to their own needs, and will not affect the work of other indoor units, nor waste the power of the refrigeration system.

The function of the multiple-driven-by-one of the present application has a great advantage, that is, it can directly adopt the outdoor unit of the single system and the indoor unit of the single system, and there is no need to develop the supporting outdoor unit and indoor unit for the multiple-driven-by-one system.

The function of the multiple-driven-by-one of the present application is very suitable to replace the high-power cabinet type air conditioner. The outdoor units with the same power are selected and matched with several low-power indoor units. During installation, these indoor units are evenly distributed in the large room. After starting up, the whole large room can be cooled evenly, which can not be realized by the cabinet air conditioner. In addition, these indoor units can adjust and control the temperature in their respective areas as required, which is impossible for cabinet air conditioners.

Similarly, the function of the multiple-driven-by-one of the present application makes it easy to form a central air conditioning system, and each indoor unit can independently control the temperature of its own area, but the cost will be lower than that of installing separate air conditioners independently. Similarly, take FIG. 2, one driving four as an example, if a house has four rooms (or four areas) that need to be installed with air conditioners of 1.5p, four outdoor units of 1.5p and four indoor units of 1.5p are required. The central air conditioning system composed of this system only needs one outdoor unit of 6p and four indoor units of 1.5p, but the manufacturing cost of one outdoor unit of 6p is lower than that of four outdoor units of 1.5p.

In actual use, it usually only needs to make the power of the air conditioner to the maximum within a short period of time after it is started up. After the indoor temperature drops, only a relatively small power is needed to maintain the indoor temperature near the set temperature. For multiple-driven-by-one systems, it is rare for all indoor units to be turned on at the same time, that is, the system rarely needs maximum power. When designing a multiple-driven-by-one system, according to the characteristics of the system, the outdoor unit can choose a unit with a power smaller than the maximum power. Taking the four-driven-by-one system in FIG. 2 as an example, it is assumed that the four indoor units are all of 1.5p. Generally, a unit of 6p is selected as the outdoor unit, and the cooling power of 1.5p is required for each indoor unit when it is started up. After the temperature is reduced to the set value, it only needs the cooling power of 0.8p to maintain the temperature at the set value. Now, suppose that two indoor units are started at the same time. At this time, the outdoor unit is required to provide a cooling power of 1.5×2=3p. When the temperature drops to the required level, only the cooling power of 0.8*2=1.6p is needed. Then the third unit is started up, in this way, the cooling power of 1.6+1.5=3.1p is required. After the temperature is reduced to the requirements, only the cooling power of 0.8*3=2.4p is needed. Then the fourth unit is started up, so the cooling power of 2.4+1.5=3.9p is required. After the temperature is reduced to the requirements, only the cooling power of 0.8*4=3.2p is needed. So the maximum cooling power of 3.9p is actually needed, the outdoor unit with cooling power of 4p instead of 6p is fine. The outdoor unit of 4p is equipped with four indoor units of 1.5p. In case of the worst case, the four indoor units will be started up at the same time, and the cooling power obtained by each unit will be 4/4=1p, which is smaller than the required power of 1.5p, which only makes the cooling slow.

### The Third Embodiment

The difference between the third embodiment and the first embodiment is that the evaporator 110 of the air conditioner of the third embodiment is arranged indoors.

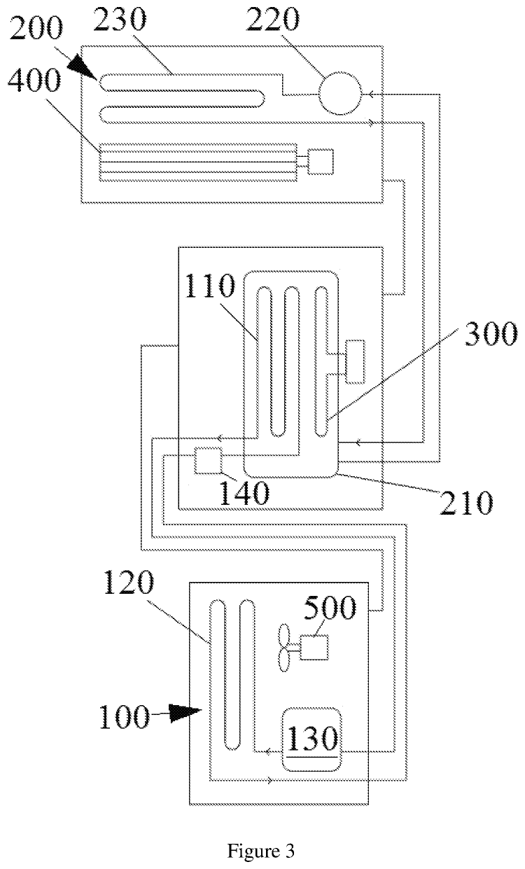

Specifically, as shown in FIG. 3, which shows the schematic diagram of the air conditioner in the third embodiment of the present application, the air conditioner comprises a first refrigeration cycle 100 and a second refrigeration cycle 200;

the first refrigeration cycle 100 comprises an evaporator 110, a condenser 120, a compressor 130 and a throttle valve 140; an outlet of the evaporator 110 is connected with an inlet of the compressor 130, an outlet of the compressor 130 is connected with an inlet of the condenser 120, an outlet of the condenser 120 is connected with an inlet of the evaporator 110 through the throttle valve 140, making the evaporator 110, the condenser 120, the compressor 130 and the throttle valve 140 being connected to form a first loop; the first refrigeration cycle 100 further comprise a refrigerant which circulates in the first loop;

the second refrigeration cycle 200 comprises an antifreeze fluid tank 210, a pump 220 and a heat exchanger 230; an outlet of the antifreeze fluid tank 210 is connected with an inlet of the pump 220, an outlet of the pump 220 is connected with an inlet of the heat exchanger 230, an outlet of the heat exchanger 230 is connected with an inlet of the antifreeze fluid tank 210, making the antifreeze fluid tank 210, the pump 220 and the heat exchanger 230 being connected to form a second loop; the second refrigeration cycle 200 further comprises an antifreeze fluid not shown in the Figure which circulates in the second loop;

the evaporator 110 is installed in the antifreeze fluid tank 210 and immersed in the antifreeze fluid in the antifreeze fluid tank 210.

The above technical scheme is the basic scheme. For the first refrigeration cycle 100, the compressor 130 sucks the working medium steam refrigerant with lower pressure from the evaporator 110, increases its pressure, and sends it to the condenser 120, where it is condensed into a liquid refrigerant with higher pressure. After throttled by the throttle valve 140, it becomes a liquid with lower pressure, and then is sent to the evaporator 110, where it absorbs heat and is evaporated into a steam with lower pressure. And the first refrigeration cycle is completed. For the second refrigeration cycle 200, since the evaporator 110 is immersed in the antifreeze fluid tank 210, the antifreeze fluid tank 210 can obtain the cooling capacity produced by the first refrigeration cycle 100 through heat transfer, and the pump 220 can deliver the cooling capacity to the heat exchanger 230 to realize the cooling function. This embodiment uses antifreeze fluid to store the cooling capacity. After the indoor temperature drops to the set temperature, the pump is turned off to stop cooling the air; the air is cooled again when the pump is turned on. Since controlling the pump to be turned on or off can be easily realized, the indoor temperature can be precisely adjusted. When the pump is turned off, since the cooling capacity is stored in the antifreeze fluid tank 210, the cooling capacity is not consumed by the antifreeze fluid in the antifreeze fluid tank (of course, the antifreeze fluid tank and pipeline cannot be completely insulated, and there will be some cooling capacity leakage), and the temperature will be nearly constant. When the pump is turned on, the cooling capacity stored in antifreeze fluid will be continuously consumed, and the temperature in the antifreeze fluid tank will continue to rise. When the temperature in the antifreeze fluid tank rises to the set value, the compressor starts to work, and the first refrigeration cycle 100 starts to produce cooling capacity. The antifreeze fluid absorbs the cooling capacity, and the temperature will continue to decrease. When the temperature decreases to the set value, the compressor stops working. The opening and closing of the compressor are controlled according to the consumption rate of antifreeze liquid cooling capacity, rather than directly controlled by temperature, so it is not necessary to turn on and turn off it frequently. Therefore, the function of fine temperature adjustment of the inverter air conditioners is realized by the fixed-frequency compressor of the air conditioner of the present application, and the energy consumption is also reduced.

It can be understood that the heat exchanger 230 is arranged indoors, and the condenser 120 and the compressor 130 are arranged outdoors. Further, in this embodiment, the evaporator 110 is arranged indoors.

Further, in this embodiment, freon is used as the refrigerant. Antifreeze fluid is a common antifreeze coolant for automobile engines, and its freezing point is less than or equal to −30° C. The antifreeze fluid used by the air conditioner of the present application transmits the cooling capacity produced by the first refrigeration cycle 100 to the indoor heat exchanger 230 of the second refrigeration cycle 200, which can easily make the internal temperature of the heat exchanger reach the required temperature (for example, at present, the split air conditioner is usually at −7° C.), and the temperature can be adjusted in a larger range according to the needs. It also has a wider adjustment range than the situation where water is used as the refrigerant in the second refrigeration cycle 200. When using water as the refrigerant, the minimum internal temperature of the heat exchanger can only be close to 0° C.

Further, in this embodiment, the air conditioner also includes a heating wire 300 arranged inside the antifreeze fluid tank 210 for heating the antifreeze fluid. When the air conditioner is used for heating, the antifreeze fluid tank, the heating wire, the pump and the heat exchanger together form a heating system, which is used to transfer the heat generated by the heating wire to the indoor heat exchanger to heat the indoor air.

In this embodiment, the first refrigeration cycle of the present application is fully enclosed and integrated, so the refrigerant used for the same power is less, and there is no leakage, so no refrigerant needs to be added for maintenance. The output pipe and return pipe of antifreeze fluid are connected from outdoor to indoor. There is no high pressure and gas state during operation. Antifreeze liquid is liquid under normal temperature and pressure. It only needs ordinary plastic barrels for storage the antifreeze liquid, and steel cylinders used for refrigerant are not needed. Therefore, the air conditioner of the present application is much more convenient in installation and maintenance than the commonly used split air conditioner at present.

Further, in the present embodiment, the air conditioner also comprises a first fan 400 arranged near the heat exchanger 230 for pumping air near the heat exchanger 230 to form an air flow.

The air conditioner also comprises a second fan 500 arranged near the condenser 120 for pumping air near the condenser 120 to form an air flow.

In this embodiment, the heat exchanger, the pump and the first fan constitute an indoor unit; the throttle valve, the evaporator, the antifreeze fluid tank, the heating wire, the compressor, the condenser and the second fan constitute the outdoor unit.

In this embodiment, the heat exchanger, the pump and the first fan constitute an indoor unit; the throttle valve, the evaporator, the antifreeze fluid tank and the heating wire constitute the indoor host; the compressor, the condenser and the second fan form the outdoor host. Because the indoor unit is only electrically connected with the indoor host, when the indoor host and the indoor unit are placed indoors, the connecting pipe of the whole air conditioner will be much shorter, the antifreeze fluid that needs to be poured will be much less, and the natural loss of cooling capacity will be much smaller.

The embodiments of the present application are described above in combination with the attached drawings, but the present application is not limited to the above specific embodiments, which are only schematic, not restrictive. Ordinary technicians in the art can make many forms under the enlightenment of the present application without departing from the scope protected by the purposes and claims of the present application, which belong to the protection of the present application.

What is claimed is:

1. An air conditioner, comprising a first refrigeration cycle (100) and a second refrigeration cycle (200);
wherein the first refrigeration cycle (100) comprises an evaporator (110), a condenser (120), a compressor (130) and a throttle valve (140); an outlet of the evaporator (110) is connected with an inlet of the compressor (130), an outlet of the compressor (130) is connected with an inlet of the condenser (120), an outlet of the condenser (120) is connected with an inlet of the evaporator (110) through the throttle valve (140), making the evaporator (110), the condenser (120), the compressor (130) and the throttle valve (140) being connected to form a first loop; the first refrigeration cycle (100) further comprise a refrigerant which circulates in the first loop;
the second refrigeration cycle (200) comprises an antifreeze fluid tank (210), a pump (220) and a heat exchanger (230); an outlet of the antifreeze fluid tank (210) is connected with an inlet of the pump (220), an outlet of the pump (220) is connected with an inlet of the heat exchanger (230), an outlet of the heat exchanger (230) is connected with an inlet of the antifreeze fluid tank (210), making the antifreeze fluid tank (210), the pump (220) and the heat exchanger (230) being connected to form a second loop; the second refrigeration cycle (200) further comprises an antifreeze fluid which circulates in the second loop;
the evaporator (110) is installed in the antifreeze fluid tank (210) and immersed in the antifreeze fluid in the antifreeze fluid tank (210).

2. The air conditioner according to claim 1, wherein, the heat exchanger (230) is arranged indoors, and the condenser (120) and the compressor (130) are arranged outdoors.

3. The air conditioner according to claim 2, wherein, the evaporator (110) is arranged indoors or outdoors.

4. The air conditioner according to claim 1, wherein, the air conditioner further comprises a heating wire (300) arranged in the antifreeze fluid tank (210) for heating the antifreeze fluid.

5. The air conditioner according to claim 1, wherein, the air conditioner further comprises a first fan (400) arranged near the heat exchanger (230) for pumping air near the heat exchanger (230) to form an air flow.

6. The air conditioner according to claim 1, wherein, the air conditioner further comprises a second fan (500) arranged near the condenser (120) for pumping air near the condenser (120) to form an air flow.

7. The air conditioner according to claim 1, wherein, there are multiple second refrigeration cycles (200), and multiple second refrigeration cycles (200) share the same antifreeze fluid tank (210).
